(19) United States
(12) Patent Application Publication
(10) Pub. No.: US 2013/0141643 A1
(43) Pub. Date: Jun. 6, 2013

(54) Audio-Video Frame Synchronization in a Multimedia Stream

(71) Applicant: DOUG CARSON & ASSOCIATES, INC., Cushing, OK (US)

(72) Inventors: Eric M. Carson, Cushing, OK (US); Henry B. Kelly, Stillwater, OK (US)

(73) Assignee: DOUG CARSON & ASSOCIATES, INC., Cushing, OK (US)

(21) Appl. No.: 13/706,032

(22) Filed: Dec. 5, 2012

Related U.S. Application Data
(60) Provisional application No. 61/567,153, filed on Dec. 6, 2011.

(51) Int. Cl. H04N 21/43

(52) U.S. Cl. CPC H04N 21/4307
USPC 348/515

(57) ABSTRACT

Apparatus and method for synchronizing audio and video frames in a multimedia data stream. In accordance with some embodiments, the multimedia stream is received into a memory to provide a sequence of video frames in a first buffer and a sequence of audio frames in a second buffer. The sequence of video frames is monitored for an occurrence of at least one of a plurality of different types of visual events. The occurrence of a selected visual event is detected that spans multiple successive video frames in the sequence of video frames. A corresponding audio event is detected that spans multiple successive audio frames in the sequence of audio frames. The relative timing between the detected audio and visual events is adjusted to synchronize the associated sequences of video and audio frames.

### RELATED APPLICATION

The present application makes a claim of domestic priority under 35 U.S.C. §119(e) to copending U.S. Provisional Patent Application No. 61/567,153 filed Dec. 6, 2011, the contents of which are hereby incorporated by reference.

### BACKGROUND

Multimedia content (e.g., motion pictures, television broadcasts, etc.) are often delivered to an end-user system through a transmission network or other delivery mechanism. Such content may have both audio and video components, with the audio portions of the content delivered to and output by an audio player (e.g., a multi-speaker system, etc.) and the video portions of the content delivered to and output by a video display (e.g., a television, computer monitor, etc.).

Such content can be arranged in a number of ways, including in the form of streamed content in which separate packets, or frames, of video and audio data are respectively provided to the output devices. In the case of a broadcast transmission, the source of the broadcast will often ensure that the audio and video portions are aligned at the transmitter end so that the audio sounds will be ultimately synchronized with the video pictures at the receiver end.

However, due to a number of factors including network and receiver based delays, the audio and video portions of the content may sometimes become out of synchronization (sync). This may cause, for example, the end user to notice that the lips of an actor in a video track do not align with the words in the corresponding audio track.

### SUMMARY

Various embodiments of the present disclosure are generally directed to an apparatus and method for synchronizing audio frames and video frames in a multimedia data stream.

In accordance with some embodiments, a multimedia stream is received into a memory to provide a sequence of video frames in a first buffer and a sequence of audio frames in a second buffer. The sequence of video frames is monitored for an occurrence of at least one of a plurality of different types of visual events. The occurrence of a selected visual event is detected, the detected visual event spanning multiple successive video frames in the sequence of video frames. A corresponding audio event is detected that spans multiple successive audio frames in the sequence of audio frames. The relative timing between the detected audio and visual events is adjusted to synchronize the associated sequences of video and audio frames.

These and other features and advantages of various embodiments can be understood in view of the following detailed description and the accompanying drawings.

### BRIEF DESCRIPTION OF DRAWINGS

FIG. 1 shows a functional block representation of a multimedia content presentation system constructed and operated in accordance with various embodiments of the present disclosure.

FIG. 2 is a representation of video and audio frames in synchronization (sync).

FIG. 3 shows portions of the system of FIG. 1 in accordance with some embodiments.

is a representation of video and audio frames that are not in sync.

FIG. 4 illustrates video encoding that may be carried out by the video encoder of FIG. 3.

FIG. 5 provides a functional block representation of portions of the synchronization detection and adjustment circuit of FIG. 3 in accordance with some embodiments.

FIG. 6 illustrates portions of the video pattern detector of FIG. 5 in accordance with some embodiments to provide speech-based synchronization adjustments.

FIG. 7 depicts various exemplary visemes and phonemes that respectively occur in the video and audio essence (streams) in a synchronized context.

FIG. 8 corresponds to FIG. 7 in an out of sync context.

FIG. 9 illustrates portions of the video pattern detector and the audio pattern detector of FIG. 5 in accordance with some embodiments to provide luminance-based synchronization adjustments.

FIG. 10 illustrates portions of the video pattern detector and the audio pattern detector of FIG. 5 in accordance with some embodiments to provide black frame based synchronization adjustments.

FIG. 11 provides various watermark modules further operative in some embodiments to enhance synchronization.

FIG. 12 shows video and audio frames as in FIG. 2 with the addition of video and audio watermarks to facilitate synchronization in accordance with the modules of FIG. 11.

FIG. 13 is a flow chart for an AUDIO AND VIDEO FRAME SYNCHRONIZATION routine carried out in accordance with various embodiments.

### DETAILED DESCRIPTION

Without limitation, various embodiments set forth in the present disclosure are generally directed to a method and apparatus for synchronizing audio and video frames in a multimedia stream. As explained below, in accordance with some embodiments a multimedia content presentation system generally operates to receive a multimedia data stream into a memory. The data stream is processed to provide a sequence of video frames of data in a first buffer space and a sequence of audio frames of data in a second buffer space.

The sequence of video frames is monitored for the occurrence of one or more visual events from a list of different types of potential visual events. These may include detecting a mouth of a talking human speaker, a flash type event, a temporary black (blank) video screen, a scene change, etc. Once the system detects the occurrence of a selected visual event from this list of events, the system proceeds to attempt to detect an audio event in the second sequence that corresponds to the detected visual event. In each case, it is contemplated that the respective visual and audio events will span multiple successive frames.

The system next operates to determine the relative timing between the detected visual and audio events. If the events are found to be out of synchronization (“sync”), the system adjusts the rate of output of the audio and/or video frames to bring the respective frames back into sync.

In further embodiments, one or more synchronization watermarks may be inserted into one or more of the audio and video sequences. Detection of the watermark(s) can be used to confirm and/or adjust the relative timing of the audio and video sequences.

In still further embodiments, audio frames may be additionally or alternatively monitored for audio events, the detection of which initiates a search for one or more corresponding visual events to facilitate synchronization monitoring and, as necessary, adjustment.

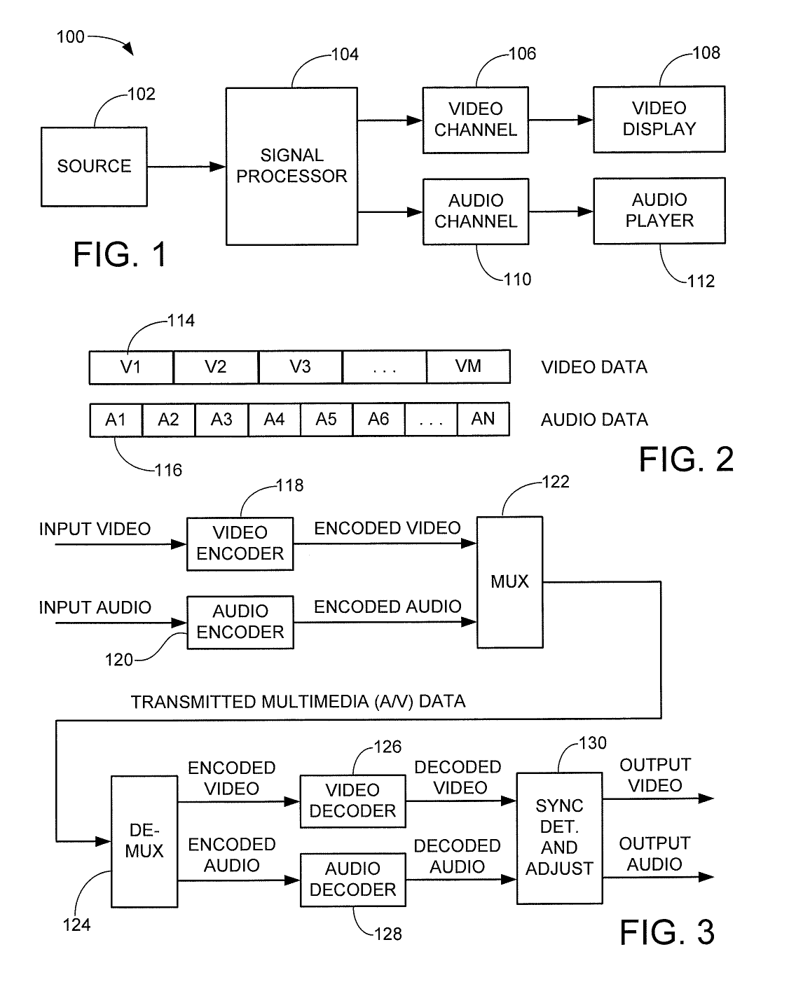

These and other features of various embodiments can be understood beginning with a review of FIG. 1, which provides a simplified functional block representation of a multimedia content presentation system 100. For purposes of the present discussion it will be contemplated that the system 100 is characterized as a home theater system with both video and audio playback devices. Such is not necessarily required, however, as the system can take any number of suitable forms depending on the requirements of a given application, such as a computer or other personal electronic device, a public address and display system, a network broadcast processing system, etc.

The system 100 receives a multimedia content data stream from a source 102. The source may be remote from the system 100 such as in the case of a television broadcast (airwave, cable, computer network, etc.) or other distributed delivery system that provides the content to one or more end users. In other embodiments, the source may form a part of the system 100 and/or may be a local reader device that outputs the content from a data storage medium (e.g., from a hard disc, an optical disc, flash memory, etc.).

A signal processor 104 processes the multimedia content and outputs respective audio and video portions of the content along different channels. Video data are supplied to a video channel 106 for subsequent display by a video display 108. Audio data are supplied to an audio channel 110 for playback over an audio player 112. The video display 108 may be a television or other display monitor. The audio channel may take a multi-channel (e.g., 7+1 audio) configuration and the audio player may be an audio receiver with multiple speakers. Other configurations can be used.

It is contemplated that the respective audio and video data will be arranged as a sequence of blocks of selected length. For example, data output from a DVD may provide respective audio and video blocks of 2352 bytes in size. Other data formats may be used.

FIG. 2 shows respective video frames 114 (denoted as V1-VM) and audio frames 116 (A1-AN). These frames are contemplated as being output to and buffered in the respective channels 106, 110 of FIG. 1 pending playback. As used herein, the term “frame” denotes a selected quantum of data, and may constitute one or more data blocks.

In some embodiments, the video frames 114 each represent a single picture of video data to be displayed by the display device at a selected rate, such as 30 video frames/second. The video data may be defined by an array of pixels which in turn may be arranged into blocks and macroblocks. The pixels may each be represented by a multi-bit value, such as in an RGB model (red-green-blue). In RGB video data, each of these primary colors is represented by a different component video value; for example, 8-bits for each color provides 256 different levels (28), and a 24 bit pixel value capable of displaying about 16.7 million colors. In YUV video data, a luminance (Y) value is provided to denote intensity (e.g., brightness) and two chrominance (UV) values denote differences in color value.

The audio frames 116 may represent multi-bit digitized data samples that are played at a selected rate (e.g., 44.1 kHz or some other value). Some standards may provide around 48,000 samples of audio data/second. In some cases, audio samples may be grouped into larger blocks, or groups, that are treated as audio frames. As each video frame generally occupies about 1/30 of a second, an audio frame may be defined as the corresponding approximately 1600 audio samples that are played during the display of that video frame. Other arrangements can be used as required, including treating each audio data block and each video data block as a separate frame.

It is contemplated that many numbers of frames of data will be played by the respective devices 108, 112 each second, and different rates of frames may be presented. It is not necessarily required that a 1:1 correspondence between the numbers of video and audio frames be maintained. More than or less than 30 frames of audio data may be played each second. However, some sort of synchronization timing will be established to nominally ensure the audio is in sync with the video irrespective of the actual numbers of frames that pass through the respective devices 108, 112.

Normally, it is contemplated that the video and audio data in the respective frames are in synchronization. That is, the video frame V1 will be displayed by the video display 108 (FIG. 1) at essentially the same time as the audio frame A1 is played by the audio player 112. In this way, the visual and audible playback will correspond and be “in sync.”

Due to a number of factors, however, a loss of synchronization can sometimes occur between the respective video and audio frames. In an out of synchronization (out of sync) condition, the audio will not be aligned in time with the video. Either signal can precede the other, although it may generally be more common for the video to lag the audio, as discussed below.

FIG. 3 illustrates portions of the multimedia content presentation system 100 of FIG. 1 in accordance with some embodiments. Respective input audio and video streams substantially correspond to the data that are to be ultimately output by the display devices 108, 112. The input video and audio streams are provided from an upstream source such as a storage medium or transmission network, and are supplied to respective video and audio encoders 118, 120.

The video encoder 118 applies signal encoding to the input video to generate encoded video, and the audio encoder 120 applies signal encoding to the input audio to generate encoded audio. A variety of types of encoding can be applied to these respective data streams, including the generation and insertion of timing/sequence marks, error detection and correction (EDC) encoding, data compression, filtering, etc.

A multiplexer (mux) 122 combines the respective encoded audio and video data sets and transmits the same as a transmitted multimedia (audio/video, or A/V) data stream. The transmission may be via a network, or a simple conduit path between processing components. A demultiplexer (demux) 124 receives the transmitted data stream and applies demultiplexing processing to separate the received data back into the respective encoded video and audio sequences. It will be appreciated that merging the signals into a combined multimedia A/V stream is not necessarily required, as the channels can be maintained as separate audio and video channels as required (thereby eliminating the need for the mux and demux 122, 124). It will be appreciated that in this latter case, the multiple channels are still considered a “multimedia data stream.”

A video decoder 126 applies decoding processing to the encoded video to provide decoded video, and an audio decoder 128 applies decoding processing to the encoded audio to provide decoded audio. A synchronization detection and adjustment circuit 130 thereafter applies synchronization processing, as discussed in greater detail below, to output synchronized video and audio streams to the display devices 108, 112 of FIG. 1 so that the audio and video data are perceived by the viewer as being synchronized in time.

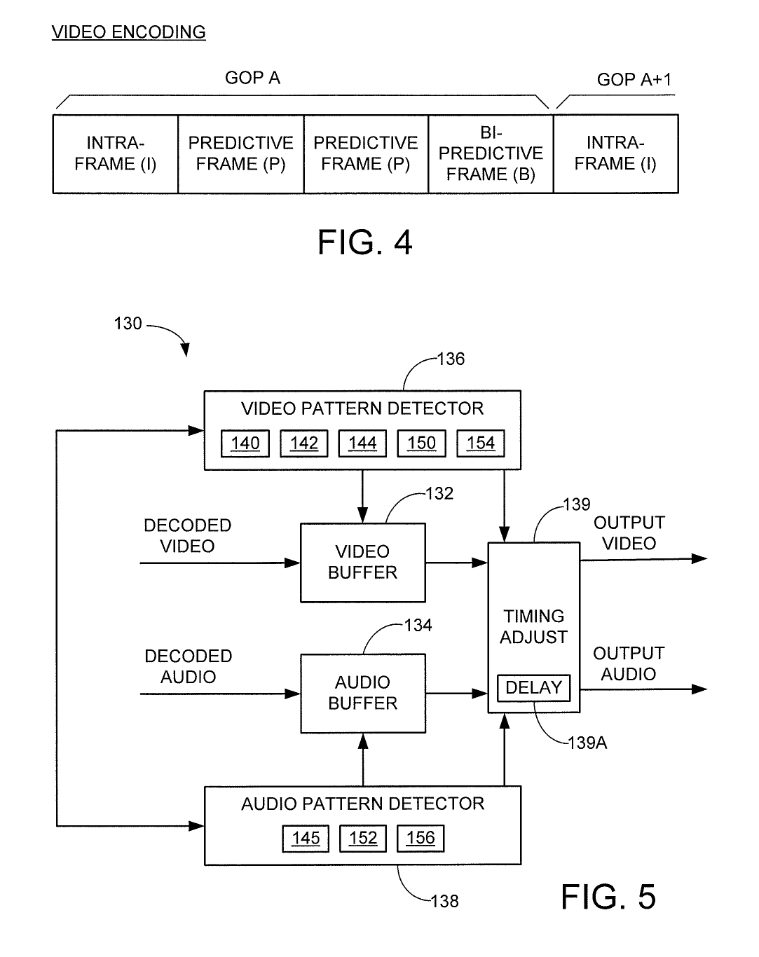

FIG. 4 illustrates an exemplary video encoding technique that can be applied by the video encoder 118 of FIG. 3. While operable in reducing the bandwidth requirements of the transmitted data, the exemplary technique can also sometimes result in out of sync conditions. Instead of representing each video data frame 114 as a full bitmap of pixels, different formats of frames can be used in a subset of frames (sometimes referred to as a group of pictures, GOP). An intra-frame (also referred to as a key frame or an I-frame) stores a complete picture of video content in encoded form. Each GOP begins with an I-frame and ends immediately prior to the next I-frame in the sequence.

Predictive frames (also referred to as P-frames) generally only store information that is different in that frame as compared to the preceding I-frame. Bi-predictive frames (B-frames) only store information that is different in that frame that is different from either the I-frame of the GOP (e.g., GOP A) or the I-frame of the immediately following GOP (e.g., GOP A+1).

The use of P-frames and B-frames provides an efficient mechanism for compressing the video data. It will be recognized, however, that the presence of both the current GOP I-frame (and in some cases, the I-frame of the next GOP) are required before the sequence of frames can be fully decoded. This can increase the decoding complexity and, in some cases, cause delays in video processing.

The exemplary video encoding scheme can also include the insertion of decoder time stamp (DTS) data and presentation time stamp (PTS) data. These data sets can assist the video decoder 126 (FIG. 3) in correctly ordering the frames for output.

Compression encoding can be applied to the audio data by the audio encoder 120 to reduce the data size of the transmitted audio data, and EDC codes can be applied (e.g., Reed Solomon, Parity bits, checksums, etc.) to ensure data integrity. Generally, however, the audio samples are processed sequentially and remain in sequential order throughout the data stream path, and may not be provided with DTS and/or PTS type data marks.

As noted above, loss of synchronization between the audio and video channels can arise due to a number of factors, including errors or other conditions associated with the operation of the source 102, the transmission network (or other communication path) between the source and the signal processor 104, and the operation of the signal processor in processing the respective types of data.

In some cases, the transmitted video frames may be delayed due to a lack of bandwidth in the transport carrier (path), causing the demux process to send audio for decoding ahead of the associated video content. The video may thus be decoded later in time than the associated audio and, without a common time reference, the audio may be forwarded in the order received in advance of the corresponding video frames. The audio output may thus be continuous, but the viewer may observe held or frozen video frames. When the video resumes, it may lag the audio.

Accordingly, various embodiments of the present disclosure generally operate to automatically detect and, as necessary, correct these and other types of out of sync conditions. FIG. 5 shows aspects of the synchronization detection and adjustment circuit 130 of FIG. 3 in accordance with some embodiments. It is contemplated that the circuit 130 can be incorporated into the system 100 in a variety of ways, such as in the signal processing block 104 of FIG. 1. However, other forms can be taken. For example, the circuit 130 can be incorporated into the video display 108, provided that the audio data are routed to the display, or in the audio player 112, provided that the video data are routed to the player, or some other module apart from those depicted in FIG. 1.

The circuit 130 receives the respective decoded video and audio frame sequences from the decoder circuits 126, 128 and buffers the same in respective video and audio buffers 132, 134. The buffers 132, 134 may be a single physical memory space or may constitute multiple memories. While not required, it is contemplated that the buffers have sufficient data capacity to store a relatively large amount of audio/video data, such as on the order of several seconds of playback content.

A video pattern detector 136 is shown operatively coupled to the video buffer 132, and an audio pattern detector 138 is operably coupled to the audio buffer 134. These detector blocks operate to detect respective visual and audible events in the succession of frames in the respective buffers. A timing adjustment block 139 controls the release of the video and audio frames to the respective downstream devices (e.g., 108, 112 in FIG. 1) and may adjust the rate at which the frames are output responsive to the detector blocks. While not separately shown, a top level controller may direct the operation of these various elements. In some embodiments, the functions of these various blocks may be performed by a programmable processor having associated programming steps in a suitable memory.

In accordance with some embodiments, the video pattern detector 136 operates, either in a continuous mode or in a periodic mode, to examine the video frames in the video buffer 132. During such detection operations, the values of various pixels in the frame are evaluated to determine whether a certain type of visual event is present. It is contemplated that the video pattern detector 136 will operate to concurrently search for a number of different types of events in each evaluated frame.

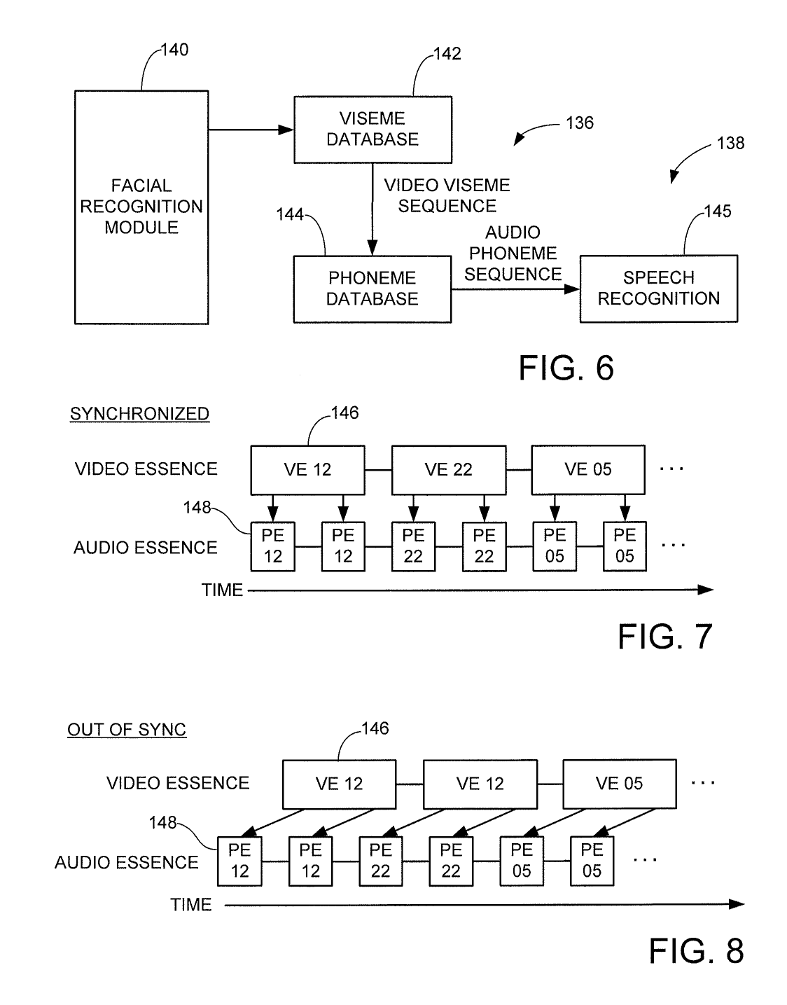

FIG. 6 is a generalized representation of portions of the video pattern detector 136 in accordance with some embodiments. A facial recognition module 140 operates to detect speech patterns by a human (or animated) speaker. The module 140 may employ well known techniques of detecting the presence of a human face within a selected frame using color, shape, size and/or other detection parameters. Once a human face is located, the mouth area of the face is located using well known proportion techniques. The module 140 may further operate to detect predefined lip/face movements indicative of certain phonetic sounds being made by the depicted speaker in the frame. It will be appreciated that the visual events relating to phonetic speaking may require evaluation over a number of successive frames and/or GOPs.

It is well known in the art that complex languages can be broken down into a relatively small number of sounds (phonemes). English can sometimes be classified as involving about 40 distinct phonemes. Other languages can have similar numbers of phonemes; Cantonese, for example, can be classified as having about 70 distinct phonemes. Phoneme detection systems are well known and can be relatively robust to the point that, depending on the configuration, such systems can identify the language being spoken by a visible speaker in the visual content.

Visemes refer to the specific facial and oral positions and movements of a speaker's lips, tongue, jaw, etc. as the speaker sounds out a corresponding phoneme. Phonemes and visemes, while generally correlated, do not necessarily share a one-to-one correspondence. Several phonemes produce the same viseme (e.g., essentially look the same) when pronounced by a speaker, such as the letters “L” and “R” or “C” and “T.” Moreover, different speakers with different accents and speaking styles may produce variations in both phonemes and visemes.

In accordance with some embodiments, the facial recognition module 140 monitors the detected lip and mouth region of a speaker, whether human or an animated face with quasi-human mouth movements, in order to detect a sequence of identifiable visemes that extend over several video frames. This will be classified as a detected visual event. It is contemplated that the detected visual event may include a relatively large number of visemes in succession, thereby establishing a unique synchronization pattern that can cover any suitable length of elapsed time. While the duration of the visual event can vary, in some cases it may be on the order of 3-5 seconds, although shorter and/or longer durations can be used as desired.

A viseme database 142 and a phoneme database 144 may be referenced by the module 140 to identify respective sequences of visemes and phonemes (visual positions and corresponding audible sounds) that fall within the span of the detected visual event. The phonemes should appear in the audio frames in the near vicinity of the video frames (and be perfectly aligned if the audio and video are in sync). It will be appreciated that not every facial movement in the video sequence may be classifiable as a viseme, and not every detected viseme may result in a corresponding identifiable phoneme. Nevertheless, it is contemplated that a sufficient number of visemes and phonemes will be present in the respective sequences to generate a unique synchronization pattern. The databases 142, 144 can take a variety of forms, including cross-tabulations that link visual (viseme) information with audible (phoneme) information. Other types of information, such as text-to-speech and/or speech-to-text, may also be included as desired based on the configuration of the system.

FIG. 7 schematically depicts a number of visemes 146 and corresponding phonemes 148 that ideally match in a synchronized condition for three (3) viseme-phoneme pairs referred to, for convenience, as VE 12/PE 12, VE 22/PE 22 and VE05/PE 05. It will be appreciated that the actual number of frames in the respective video and audio essence (streams) may vary so FIG. 7 is merely representational. Nevertheless, it can be seen that for phoneme PE 12 in the audio essence, the corresponding viseme VE 12 in the video essence will be essentially synchronized in time.

By contrast, FIG. 8 schematically depicts the same visemes 146 and phonemes 148 in an out of sync context. In this case, the video essence stream has been delayed with respect to the audio essence stream. Thus, the audible speech by the speaker in saying certain words will be heard before the speaker's mouth is seen to move in such a way as to pronounce those words.

The facial recognition module 140 may operate to supply the sequence of phonemes from the database 142 to a speech recognition module 145 of the audio pattern detector 138. In turn, the detector 138 analyzes the audio frames to search for an audio segment with the identified sequence of phonemes. If a match is found, the resulting audio frames are classified as a detected audio event, and the relative timing between the detected audio event and the detected visual event is determined by the timing circuit 139. Adjustments in the timing of the respective sequences are thereafter made to resynchronize the audio and video streams; for example, if the video lags the audio, samples in the audio may be delayed to resynchronize the audio with the video essence.

The audio pattern detector 138 can utilize a number of known speech recognition techniques to analyze the audio frames in the vicinity of the detected visual event. Filtering and signal analysis techniques may be applied to extract the “speech” portion of the audio data. The phonemes may be evaluated using relative values (e.g., changes in relative frequency) and other techniques to compensate for different types of voices (e.g., deep bass voices, high squeaky voices, etc.). Such techniques are well known in the art and can readily be employed in view of the present disclosure.

It will be appreciated that speech-based synchronization techniques as set forth above are suitable for video scenes which show a human (or anthropomorphic) speaker in which the speaker's mouth/face is visible. It is possible, and indeed, contemplated, that the system can be alternatively or additionally configured to monitor the audio essence for detected speech and to use this as an audio event that initiates a search of the video for a corresponding speaker. While operable, it is generally desirable to use video detection as the primary initializing factor for speech-based synchronization. This is based on the fact that it is common to have audible speech present in the audio stream without necessarily providing a visible speaker's mouth in the video stream, as in the case of a narrator, a person speaking off camera or while facing away from the viewer's vantage point, etc.

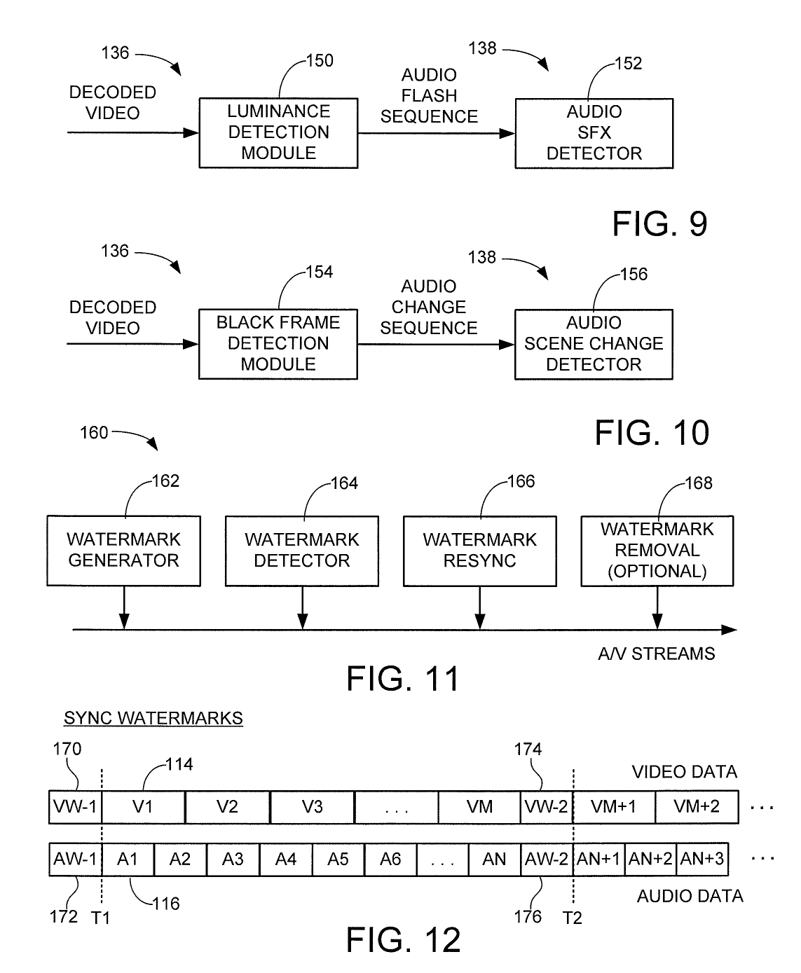

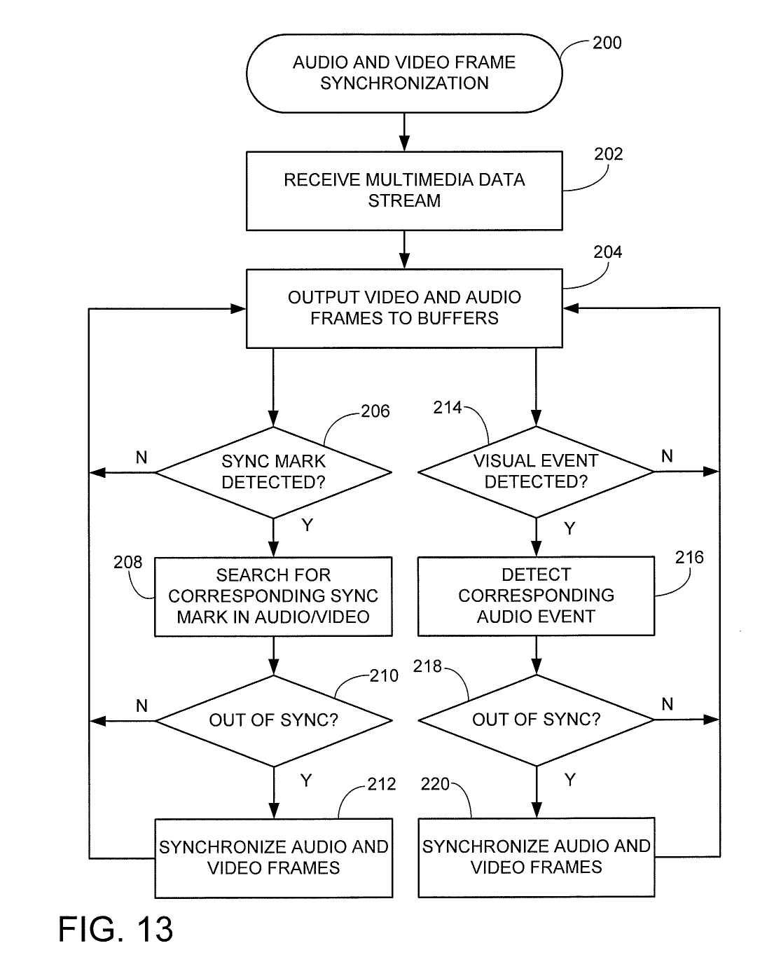

Other types of visual-audio synchronization can be implemented apart from speech-based synchronization. FIG. 9 shows the circuit 130 to further include a luminance detection module 150. The module 150 monitors the video stream for visual events that may be characterized as “flash” events, such as but not limited to explosions, gunfire, or other events that involve a relatively large change in luminance over a relatively short period of time. The module 150 can operate in parallel with, or in lieu of, the module 140 of FIG. 6.

Flash events may span multiple successive video frames, and may provide a set of pixels in a selected video frame with relatively high luminance (luma-Y) values. A forward and backward search of immediately preceding and succeeding video frames may show an increase in intensity of corresponding pixels, followed by a decrease in intensity of the corresponding pixels. Such event may be determined to signify a relatively large/abrupt sound effect (SFX) in the audio channel.

Accordingly, the location and relative timing of the flash visual event can be identified in the video frames as a detected visual event. This information is supplied to an audio SFX detector block 152 of the audio pattern detector 138 (FIG. 4), which commences a search of the audio data samples to see if a corresponding audio sound is present in the audio stream. Signal processing analysis can be applied to the audio stream in an effort to detect a significant, broad-band audio event (e.g., an explosion, gun shot, etc.). A large increase in audio level slope (e.g., change in volume) followed by a similar decrease may be present in such cases.

It will be appreciated that not all flash type visual events will necessarily result in a large SFX type audio event; the visual presentation of an explosion in space, a flashbulb from a camera, curtains being jerked open, etc., may not produce any significant corresponding audio response. Moreover, the A/V work may intentionally have a time delay between a flash event and a corresponding sound, such as in the case of an explosive blast that takes place a relatively large distance away from the viewer's vantage point (e.g., the flash is seen, followed a few moments later by a corresponding concussive event).

Some level of threshold analysis may be applied to ensure that the system does not inadvertently insert an out of sync condition by attempting to match intentionally displaced audio and visual (video) events. For example, an empirical analysis may determine that most out of sync events occur over a certain window size (e.g., +/−X video frames, such as on the order of half a second or less), so that detected video and audio events spaced greater in time than this window size may be rejected. Additionally or alternatively, a voting scheme may be used such that multiple out of sync events (of the same type or of different types) may be detected before an adjustment is made to the audio/video timing.

FIG. 10 illustrates further aspects of the circuit 130 in accordance with some embodiments. FIG. 10 illustrates a black frame detection module 154 that may be incorporated into the circuit 130 of FIG. 3. Generally, the module 154 operates concurrently with the modules 140, 150 discussed above in an effort to detect frames in which little or no visual data are expressed (e.g., dark or black frames). Additionally or alternatively, the module 154 may detect abrupt changes in scene.

The idea is that such video frames may, at least in some instances, be accompanied by a temporary silence or other step-wise change in the audio data, as in the case of a scene change (e.g., abrupt change in the visual content with regard to the displayed setting, action, or other parameters). A climaxing soundtrack of music or other noise, for example, may abruptly end with a change of visual scene. Conversely, an abrupt increase in noise, music and/or action sounds may commence with a new scene, such as a cut to an ongoing battle, etc.

Thus, a detected black frame and/or a detected visual scene change by the visual detection module 154 may be reported to an audio scene change detector 156 of the module 130 (FIG. 3), which will commence with an analysis of the corresponding audio data for a step-wise change in the audio stream. As before, verification operations such as filtering, voting, etc. may be applied to ensure that an out of sync condition is not inadvertently induced because of the presence of audio content in an extended blackened video scene.

Other forms of visual events can be searched for as desired, so that the foregoing examples are merely illustrative and not limiting. Sharp visual transitions (e.g., an abrupt transition from a relatively dark frame to a relatively light frame or vice versa without necessarily implying a concussive event) can be used to initiate a search for a corresponding audio event. A sequence in a movie where a frame suddenly shifts to a large and imposing figure (e.g., an enemy starship, etc.) may correspond to a sudden increase in the vigor of the underlying soundtrack. The modules discussed above can be configured to detect these and other types of visual events.

It will further be appreciated that the searching need not necessarily be initiated at the video level. That is, in alternative embodiments, a stepwise change in audio, including speech recognition, large changes in ambient volume level, music, noise or other events may be classified as an initially detected audio event. Circuitry as discussed above can be configured to correspondingly search for visual events that would likely correspond to the detected audio event(s).

In other embodiments, both the visual pattern detector 136 and the audio pattern detector 138 concurrently operate to examine the respective video and audio streams for detected video and audio events, and when one is found, signal to the other detector to commence searching for a corresponding audio or visual event.

In still further embodiments, one of the detectors may take a primary role and the secondary detector may take a secondary role. The audio pattern detector 138, for example, may continuously monitor the audio and identify sections with identifiable event characteristics (e.g., human speech, concussive events, step-wise changes in audio levels/types of content, etc.) and maintain a data structure of recently analyzed events. The video pattern detector 136 can operate to examine the video stream and detect visual events (e.g., human face speaking, large luminance events, dark events, etc.). As each visual event is detected, the video pattern detector 136 signals the audio pattern detector 138 to examine the most recently tabulated audio events for a correlation. In this way, at least some of the processing can be carried out concurrently, reducing the time to make a final determination of whether the audio and video streams are out of sync, and by how much.

The system can further be adapted to insert watermarks into the A/V streams of data at appropriate locations to confirm synchronization of the audio and video essences at particular points. FIG. 11 generally illustrates a watermark system at 160 in accordance with some embodiments. The system 160 includes a series of modules including a watermark generator 162, a watermark detector 164, a watermark resynchronization (resync) module 166 and a watermark removal block 168. The various modules are optional and can be added or deleted individually or in groups. The modules can be implemented at various stages in the processing of the A/V data, as required.

Generally, the watermark generator 162 can operate to insert relatively small watermarks, or synchronization timing data sets, into the respective video and audio data streams. FIG. 12 depicts the video frames 114 and audio frames 116 previously discussed in FIG. 2. In FIG. 12, a first video watermark (VW-1) 170 has been inserted into the video frames 114, and a corresponding first audio watermark (AW-1) 172 has been inserted at a presentation time T1. The watermarks 170, 172 can take any number of forms, including relatively small numerical values that enable the respective watermarks to be treated as a pair. Generally, the watermarks signify that the immediately following video frame V1 should be displayed essentially at the same time as immediately following audio frame A1. The watermarks themselves need not necessarily be aligned in time, so long as the watermarks signify this correspondence between V1 and A1. For example, the watermarks may signify that a selected audio frame X should be aligned in time with a corresponding video frame Y, with the respective frames X and Y located any arbitrary distances from the watermarks in the respective sequences.

FIG. 12 further shows a second set of watermarks VW-2 and AW-2 depicted at 174 and 176, respectively. This second set of watermarks 174, 176 indicate time-correspondence of video frame VM+1 and AN+1 at time T2. As many watermarks can be inserted by the watermark generator 162 as desired.

The generator 162 can insert the watermarks as a result of the operation of the synchronization detection and adjustment circuit 130 (FIG. 3) during a first pass through the system. That is, the watermarks can be inserted responsive to the detection of a visual event and a corresponding audio event. Thereafter, the watermarks can be retained in the data for subsequent transmission/analysis and used to ensure downstream synchronization by the circuit 130. In other embodiments, the generator 162 can be incorporated upstream of the circuit 130, such as by the video and audio encoders 118, 120, for subsequent analysis by the circuit 130. In this latter case, the input data streams may be presumed to be in sync and the watermarks are inserted on a periodic basis (e.g., every 10 seconds, etc.).

The watermark detector 164 operates to monitor the A/V stream and detect the respective watermarks (e.g., 170, 172 or 174, 176, etc.) in the respective streams. Nominally, the watermarks should be detected at about the same time or otherwise should be detected such that the calculated time (based on data I/O rates and placement of the respective frames in the buffers) at which the corresponding frames will be displayed will be about the same.

To the extent that an out of sync condition is detected based on the watermarks, the watermark resync module 166 operates to initiate an appropriate correction in the respective timing of the streams. In some cases, if the watermarks are not to remain in the respective streams the removal module 168 may remove the watermarks prior to being output by the respective output devices 108, 112 (FIG. 1). Alternatively, the watermarks may be permanently embedded in the data and used during subsequent playback operations.

FIG. 12 shows a flow chart for an AUDIO AND VIDEO FRAME SYNCHRONIZATION routine 200, illustrative of steps that may be carried out in accordance with some embodiments by the system 100 of FIG. 1. It will be appreciated that the various steps are merely exemplary and are not limiting. Other steps may be used, and the various steps shown may be omitted or performed in a different order. It will be understood that the routine 200 may represent continuous or periodic operation upon a stream of data, so that the various steps are repeated again and again as new frames are provided to the buffer space.

In FIG. 12, a multimedia data stream is received from a source (such as source 102, FIG. 1) and stored in a suitable memory location, as generally depicted by step 202 in FIG. 12. Appropriate processing is applied to the received content to output the data along appropriate channels such as a video channel and an audio channel, step 204. The frames of data may be stored in suitable buffer memory, such as the buffer memories 132, 134 in FIG. 5.

In some embodiments, the audio and video data may be provided with separate sync marks that occur on a periodic rate that indicate that a certain video frame should be aligned with a certain audio frame. The sync marks may form a portion of the displayed audio or video content, or may be overhead data (e.g., frame header data, etc.) that do not otherwise get displayed/played. The sync marks may be the watermarks 170-176 discussed above in FIGS. 10-11. In such embodiments, the routine may operate to search for and identify these sync marks and, when such are identified, to determine the relative timing of the frames and make adjustments thereto as required to maintain synchronization of the audio and video frames. For example, some types of both video and audio content have embedded time codes that may indicate when certain blocks of data should be played.

Accordingly, decision step 206 determines whether such a sync mark is detected. The marks may be present in either or both the video and audio frames, so either or both may be searched as desired. If no sync mark is detected, the routine returns to step 204 and further searching of additional frames may be carried out.

If such a sync mark is detected, the routine continues to step 208 in which a search is performed for a corresponding mark in the associated audio or video frames. In some embodiments, an indicator in one type of frame (e.g., a selected video frame) may provide an address or other overhead identifier for a corresponding audio frame that should be aligned with the selected video frame. In such case, the search in step 208 may operate to locate the other frame.

The relative timing of the respective frames is next determined and this relative timing will indicate whether the frames are out of sync, as indicated by step 210. A variety of processing approaches can be used. In some embodiments, the frames are respectively output by the buffers at regular rates, so the “time until played” can be easily estimated in relation to the respective positions of the frames in their respective buffers. Other timing evaluation techniques can be employed as desired. The amount of time differential between the expected times when the respective audio and video frames are expected to be output can be calculated and compared to a suitable threshold, and adjustments only made if the differential exceeds this threshold.

If adjustment is deemed necessary, the routine continues to step 212 where the timing adjustment block 139 (FIG. 5) adjusts the relative timing of the frames. In some embodiments, the audio frames may be sped up or slowed down to achieve the desired alignment. Certain ones of the audio samples may be dropped to speed up the audio. Alternatively, the audio may be slowed down to achieve the desired alignment using known techniques. While it is considered relatively easier to adjust the audio rate, in further embodiments, the video rate is additionally or alternatively adjusted. For example, to delay the video rate, certain frames may be repeated and inserted into the video stream, and to advance the video rate, certain frames may be removed. Such adjustments are well within the ability of the skilled artisan in view of the present disclosure.

Concurrently with the sync mark searching (if such is employed), the exemplary routine of FIG. 12 further operates to monitor the video channel for the occurrence of one or more visual events, decision step 214. As explained above, a number of different types of visual events can be pre-identified so that the system concurrently searches for the occurrence of at least one such event over a succession of frames. Human speech, flash events, dark frames, overall luma intensity changes are examples of the various types of visual events that may be concurrently searched for during this operation.

As shown by step 216, upon the detection of a visual event, a search is made to determine whether a corresponding audio event is present in the buffered audio frames. It is noted that in some cases, the detection of a visual event may not necessarily mean that a corresponding audio event will be present in the audio data. For example, an explosion depicted as occurring in space should normally not involve any sound, so a flash may not provide any useful correlation information in the audio track. Similarly, a human face may be depicted as speaking, but the words being said are intentionally unintelligible in the audio track, and so on.

Nevertheless, at such time that an audio event is detected in the audio frames, a determination is made as described above to see whether the respective audio and visual events are out of sync, step 218. If so, adjustments to the timing of the video and/or audio frames are made to bring these respective channels back into synchronization.

Numerous variations and enhancements will occur to the skilled artisan in view of the present disclosure. For example, heuristics can be maintained and used to adjust the system to improve its capabilities. The process can be concurrently performed in reverse order so that a separate search of the audio samples can be carried out during the video frame searching to determine whether a search may be made for visual events; for example, loud explosions, transitions in audio, initiating of detected human speech may trigger a search for corresponding imagery in the video data.

As used herein, different types of visual events and the like will be understood consistent with the foregoing discussion to describe different types or classes of video characteristics, such as detection of a human or anthropomorphic speaker, a luminance event, a dark frame event, a change in scene transition, etc.

The various embodiments disclosed herein can provide a number of benefits. Existing aspects of the audio and video data streams can be used to ensure and, as necessary, adjust synchronization. The techniques disclosed herein can be adapted to substantially any type of content, including animated content, sporting events, live broadcasts, movies, television programs, computer and console games, home movies, etc. It is to be understood that even though numerous characteristics and advantages of various embodiments of the present disclosure have been set forth in the foregoing description, together with details of the structure and function of various embodiments, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. A method comprising:
receiving a multimedia data stream into a memory to provide a sequence of video frames of data in a first buffer and a sequence of audio frames of data in a second buffer;
monitoring the sequence of video frames for an occurrence of at least one of a plurality of different types of visual events;
detecting the occurrence of a selected visual event from among said plurality of different types of visual events that spans multiple successive video frames in the sequence of video frames;
detecting an audio event that spans multiple successive audio frames in the sequence of audio frames corresponding to the detected visual event; and
adjusting a relative timing between the detected visual event and the detected audio event to synchronize the associated sequences of video and audio frames.

2. The method of claim 1, in which the selected visual event comprises a visual depiction of a mouth of a speaker moving in relation to a sequence of visemes, and the detected audio event comprises a plurality of phonemes corresponding to said visemes.

3. The method of claim 1, in which the selected visual event comprises a localized change in luminance in the sequence of video frames, and the corresponding audio event comprises a localized change in audio content corresponding to the localized change in luminance.

4. The method of claim 3, in which the localized change of luminance is a video depiction of an explosion, and the localized change in audio content is a relatively large concussive audio response associated with the explosion.

5. The method of claim 1, in which the selected visual event comprises a dark video frame, and the detected audio event comprises a substantially silent audio response.

6. The method of claim 1, in which the selected visual event comprises a change of scene, and the detected audio event comprises a step-wise change in audio content corresponding to the change of scene.

7. The method of claim 1, in which detecting the occurrence of a selected visual event comprises using a facial recognition module to examine the sequence of video frames to detect a human or anthropomorphic mouth moving in accordance with at least one viseme, and in which detecting an audio event comprises using a speech recognition module to identify the audio event as one or more phonemes corresponding to the at least one viseme.

8. The method of claim 1, in which adjusting a relative timing comprises selectively delaying presentation of a selected one of the sequence of video frames or the sequence of audio frames so that a video presentation of the sequence of video frames on a video display device is synchronized with an audio presentation of the sequence of audio frames on an audio player device with respect to a human observer.

9. The method of claim 1, further comprising inserting a video watermark into the sequence of video frames and a corresponding audio watermark into the sequence of audio frames, subsequently detecting the respective video and audio watermarks, and selectively delaying, responsive to a difference in timing between the video watermark and the audio watermark, a selected one of the one of the sequence of video frames or the sequence of audio frames so that a video presentation of the sequence of video frames on a video display device is synchronized with an audio presentation of the sequence of audio frames on an audio player device with respect to a human observer.

10. The method of claim 1, in which first and second visual events are detected and used to synchronize the associated sequences of video and audio frames, the first visual event comprising a mouth of a speaker corresponding to an audio speech segment and the second visual event comprising a change in luminance level in the video frames corresponding to an audio concussive segment.

11. The method of claim 1, further comprising transferring the sequence of video frames to a display device in conjunction with transferring the sequence of audio frames to an audio player to provide a multimedia presentation of both audio and video content for a human observer, wherein the adjusted relative timing causes the audio content to essentially align in time with the video content for said human observer.

12. An apparatus comprising:
a memory comprising a first buffer space adapted to receive a sequence of video frames of data from a multimedia data stream and a second buffer space adapted to receive a corresponding sequence of audio frames of data from the multimedia data stream;
a video pattern detector adapted to monitor the first buffer space for an occurrence of at least one of a plurality of different types of visual events in the sequence of video frames;
an audio pattern detector adapted to monitor the second buffer space for an occurrence of at least one of a plurality of different types of audio events in the sequence of audio frames; and
a timing adjustment circuit adapted to adjust a relative timing between the respective sequences of video and audio frames to synchronize, in time, a human perceptible video output presentation from the video frames with a human perceptible audio output presentation from the audio frames, the timing adjustment circuit adjusting the relative timing responsive to a detected visual event from said plurality of different types of visual events that spans a selected plurality of successive video frames in the sequence of video frames and a corresponding detected audio event from said plurality of different types of audio events that spans a selected plurality of successive audio frames.

13. The apparatus of claim 12, in which the video pattern detector comprises a facial recognition module, a database of visemes and a database of corresponding phonemes, the facial recognition module adapted to identify the detected visual event as a moving mouth of a speaker in the sequence of video frames and to identify a set of phonemes from said databases corresponding to the detected visual event.

14. The apparatus of claim 13, in which the audio pattern detector comprises a speech recognition module adapted to identify the detected audio event as a selected set of the audio frames having an audio content corresponding to the set of phonemes.

15. The apparatus of claim 12, in which the video pattern detector comprises a luminance detection module adapted to identify the detected visual event as a localized increase in luminance in the sequence of video frames, and in which the audio pattern detector comprises a special sound effects (SFX) detector adapted to identify the detected audio event as a concussive audio response in the audio frames corresponding to the localized increase in luminance.

16. The apparatus of claim 12, in which the video pattern detector comprises a dark video frame detection module adapted to identify the detected visual event as a frame-wide decrease in luminance in a set of video frames in the sequence of video frames, the audio pattern detector comprising a scene change detector adapted to identify the detected audio event as a detected reduction in audio response in a set of audio frames in the sequence of audio frames corresponding to the set of video frames.

17. The apparatus of claim 12, in which the timing adjustment circuit determines a total elapsed time difference between a second detected visual event and a second detected audio event, and makes no change in the relative timing of the audio and video frame sequences responsive to the total elapsed time difference exceeding a predetermined threshold.

18. The apparatus of claim 12, in which the timing adjustment circuit comprises a delay element through which a selected portion of the sequence of audio frames is passed to delay said selected portion with respect to the sequence of video frames.

19. The apparatus of claim 12, further comprising:
a timing watermark generator adapted to insert a video watermark into the sequence of video frames and to insert a corresponding audio watermark into the sequence of audio frames;
a timing watermark detector adapted to detect a relative timing between the video watermark and the audio watermark, wherein the timing adjustment circuit adjusts the relative timing between the sequences of audio and video frames responsive to the detected relative timing from the timing watermark detector.

20. An apparatus comprising:
a memory comprising a first buffer space adapted to receive a sequence of video frames of data from a multimedia data stream and a second buffer space adapted to receive a corresponding sequence of audio frames of data from the multimedia data stream; and
means for identifying an elapsed time interval between a detected visual event present in multiple successive video frames of the sequence of video frames and a detected audio event present in multiple successive audio frames of the sequence of audio frames and for resynchronizing the sequence of video frames and the sequence of audio frames responsive to the identified elapsed time interval.

21. The apparatus of claim 20, in which the detected visual event comprises a sequence of visemes corresponding to movements of a speaker's mouth depicted in said multiple successive video frames and in which the detected audio event comprises a sequence of phonemes corresponding to audio content present over said multiple successive audio frames.

22. The apparatus of claim 20, in which the detected visual event comprises a localized increase in luminescence levels of pixels in the multiple successive video frames and the detected audio event comprises an increase in audio level corresponding to a concussive audio event in said multiple successive audio frames.

23. The apparatus of claim 20, in which the detected visual event comprises a frame-wide decrease to minimum of luminescence levels of pixels in the multiple successive video frames and the detected audio event comprises a decrease in audio level corresponding to a period of relative silence in audio content in said multiple successive audio frames.
